(19) United States
(12) Patent Application Publication
(10) Pub. No.: US 2015/0113252 A1
(43) Pub. Date: Apr. 23, 2015

(54) THREAD CONTROL AND CALLING METHOD OF MULTI-THREAD VIRTUAL PIPELINE (MVP) PROCESSOR, AND PROCESSOR THEREOF

(71) Applicant: SHENZHEN ZHONGWEIDIAN TECHNOLOGY LIMITED, Nanshan, Shenzhen, Guangdong (CN)

(72) Inventors: Simon Moy, Shenzhen (CN); Chang Liao, Shenzhen (CN); Qianxiang Ji, Shenzhen (CN); David Ng, Shenzhen (CN); Stanley Law, Shenzhen (CN)

(21) Appl. No.: 14/353,110

(22) PCT Filed: Jun. 7, 2013
(86) PCT No.: PCT/CN2013/076964

§ 371 Date: Apr. 21, 2014

(30) Foreign Application Priority Data
Jun. 13, 2012 (CN) 201210195838.1

(51) Int. Cl. G06F 9/38; G06T 1/20

(52) U.S. Cl. CPC G06F 9/3851; G06T 1/20; G06T 2200/28
USPC 712/215

(57) ABSTRACT

The present invention relates to a thread control method of a multi-thread virtual pipeline (MVP) processor, which comprises the following steps: allocating directly and sequentially threads in a central processing unit (CPU) thread operation queue to multi-path parallel hardware thread time slots of the MVP processor for operation; allowing an operating thread to generate hardware thread call instructions corresponding thereto to a hardware thread management unit; allowing the hardware thread management unit to enable the call instructions of ithread threads to form a program queue according to receiving time, and calling and preparing the hardware threads; and allowing the hardware threads to operate sequentially in idle multi-path parallel hardware thread time slots of the MVP processor according to the sequence of the hardware threads in the queue of the hardware thread management unit. The present invention also relates to a processor.

### FIELD OF THE INVENTION

The present invention relates to the field of processors, in particular to a thread control and calling method of a multi-thread virtual pipeline (MVP) processor and a processor thereof.

### BACKGROUND OF THE INVENTION

In a general multi-core processor, threads of the multi-core processor are usually allocated by central processing unit (CPU) thread management units to a plurality of processor inner cores for operation. In an MVP processor, generally, graphics processing unit (GPU) threads are taken as CPU threads for processing, and the GPU threads are called and allocated by CPU thread management units. In general, when the threads operate on the above inner cores, some new thread calls may be produced, for instance, render threads. In the prior art, the called threads will also be managed by the above CPU thread management units, that is to say, when the above new threads are called by an operating thread, the called new threads will be added into an operation queue of the CPU thread management unit, wait for idle inner cores together with other threads in the queue, and can only operate on the above inner cores when the inner cores are idle and it's the threads' turn to operate. Moreover, when the new threads require hardware acceleration, as the threads are taken as the CPU threads for processing, in some cases, for instance, when timer interrupt of the inner cores may occur due to long waiting time, the inner cores for operating the threads (threads for generating new thread calls) must be used by other threads, which involves complex data storage and access. In this case, not only the operation is complex but also the execution time of the whole thread is further prolonged. Therefore, by adoption of the traditional processing method, the waiting time of the called new threads may be longer and the operation may be more complex.

### SUMMARY OF THE INVENTION

The technical problem to be solved by the present invention is to overcome the defects of longer waiting time and more complex operation in the prior art and provide a thread control and calling method of an MVP processor with short waiting time and simple operation, and the processor thereof.

In order to solve the technical problem, the present invention adopts the technical proposal that: the present invention relates to a thread control and calling method of an MVP processor, which comprises the following steps:

A) allocating directly and sequentially threads in a CPU thread operation queue to multi-path parallel hardware thread time slots of the MVP processor for operation;

B) allowing an operating thread to generate hardware thread call instructions corresponding thereto to a hardware thread management unit;

C) allowing the hardware thread management unit to enable the ithread (hardware thread) call instructions to form a program queue according to receiving time, and calling and preparing ithread threads; and

D) allowing the ithread threads to operate sequentially in idle multi-path parallel hardware thread time slots of the MVP processor according to the sequence of the ithread threads in the queue of the hardware thread management unit.

In the thread control and calling method of the MVP processor provided by the present invention, the ithread is a hardware thread and includes a graphics engine, a digital signal processor (DSP) and/or a thread requiring hardware acceleration in a general-purpose computing on graphics processing unit (GPGPU).

In the thread control and calling method of the MVP processor provided by the present invention, the step A) further includes the following steps:

A1) determining whether there are hardware threads which are valid and not finished in the hardware thread management unit, and executing step A2) if so and executing step A3) if not;

A2) removing the current idle multi-path parallel hardware thread time slot from a CPU thread management unit, prohibiting the thread timer interrupt of the parallel hardware thread time slot, and allocating the idle multi-path parallel hardware thread time slot to the hardware thread management unit for control; and

A3) waiting and returning idle information of the parallel hardware thread time slot to the CPU thread management unit.

In the thread control and calling method of the MVP processor provided by the present invention, the step C) further includes the following steps:

C1) removing ithread threads in the front of the program queue of the hardware thread management unit; and

C2) allocating obtained executable functions to the idle hardware thread time slot for operation.

In the thread control and calling method of the MVP processor provided by the present invention, the queuing discipline of the program queue in the step C) is first-in-first-out (FIFO).

In the thread control and calling method of the MVP processor provided by the present invention, the method further comprises the following step:

E) allowing the ithread threads to retreat from the hardware thread time slots on which the ithread threads operate and enabling the thread timer interrupt of the time slots, when the ithread threads are finished or wait for an event for the continuous execution of the ithread threads.

In the thread control and calling method of the MVP processor provided by the present invention, the method further comprises the following step:

F) allowing the hardware thread management unit to detect whether the valid state of the ithread threads in the program queue of the hardware thread management unit is cleared, and removing the ithread threads if so and maintaining the ithread threads if not.

In the thread control and calling method of the MVP processor provided by the present invention, in the step B), when the operating thread operates under the kernel mode of the processor, a driver of the thread directly generates the ithread call instructions and sends the ithread call instructions to an instruction queue of the hardware thread management unit.

In the thread control and calling method of the MVP processor provided by the present invention, in the step B), when the operating thread operates under the user mode of the processor, virtual pthread received by an operating system (OS) symmetric multi-processing (SMP) scheduler is created to operate and produce the ithread call instructions and send the ithread call instructions to the instruction queue of the hardware thread management unit, in which the pthread is an OS thread.

The present invention also relates to an MVP processor for implementing the method, which comprises a plurality of parallel processor hardware inner cores configured to operate threads and system thread management units configured to manage the threads in the processor and allocate the threads to the processor hardware inner cores for operation, and further comprises hardware thread management units configured to receive and manage ithread threads generated by the operating thread and allocate the ithread threads to idle processor hardware inner cores for operation by means of coprocessor threads; the hardware thread management units are connected with the plurality of parallel processor inner cores respectively; and wherein the ithread is a hardware thread.

In the MVP processor provided by the present invention, the hardware thread management unit receives the ithread call instructions generated by the operating thread on the processor hardware inner core and sends called and ready threads to the plurality of processor hardware inner cores for operation.

In the MVP processor provided by the present invention, the hardware thread management unit also transmits the state of the called thread to a system thread management unit though a third data line.

In the MVP processor provided by the present invention, the plurality of processor hardware inner cores also respectively transmit pthread/ithread call instructions generated by the threads operating under the user state to the system thread management units through respective fourth data lines.

In the MVP processor provided by the present invention, the plurality of processor hardware inner cores and the system thread management units are respectively connected with each other through timer interrupt request signal lines for transmitting timer interrupt signals of respective hardware inner cores.

The thread control and calling method of the MVP processor and the processor thereof, provided by the present invention, have the advantages that: as newly generated hardware threads are directly called by the hardware thread management units and do not need to queue in the system thread management units, when the inner cores are idle, the hardware threads can be operated immediately, and hence the waiting time of the threads is greatly reduced; and meanwhile the possibility of timer interrupt is also greatly reduced, and hence the operation is relatively simple.

### BRIEF DESCRIPTION OF THE DRAWINGS

FIG. 1 is a flowchart of a thread control method in the embodiment of the thread control and calling method and the processor thereof provided by the present invention;

FIG. 2 is a flowchart illustrating the step of determining whether there are hardware threads in the thread control method provided by the embodiment;

FIG. 3 is a flowchart illustrating the operation and conversion of threads on hardware thread time slots in the thread control method provided by the embodiment;

FIG. 4 is a schematic diagram of one accelerating mode of a part with concentrated calculation amount in an application in the embodiment;

FIG. 5 is a schematic diagram of another accelerating mode of the part with concentrated calculation amount in the application in the embodiment; and

FIG. 6 is a schematic structural view of a processor provided by the embodiment.

### DETAILED DESCRIPTION OF THE PREFERRED EMBODIMENTS

Further description will be given to the embodiments of the present invention with reference to the accompanying drawings.

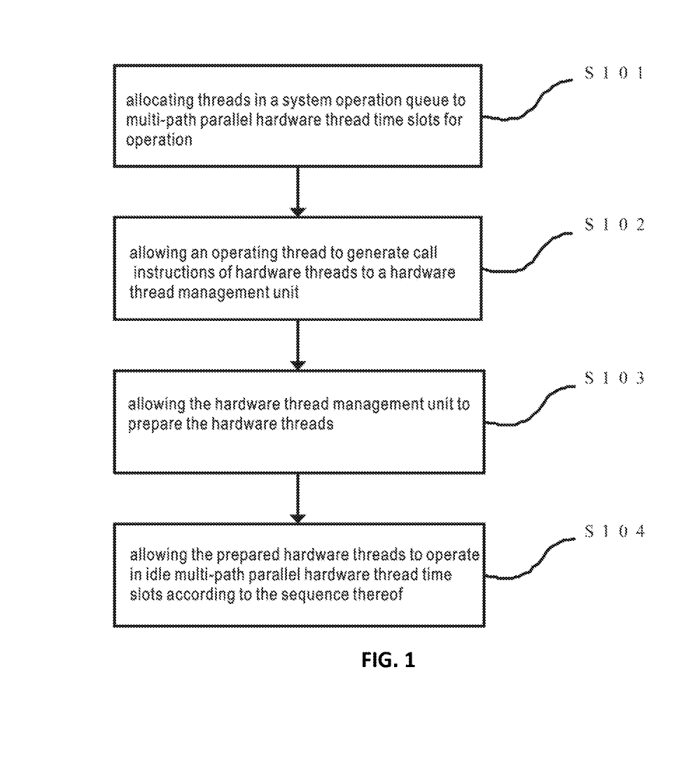

As illustrated in FIG. 1, in the embodiment of the thread control and calling method of the MVP processor and the processor thereof provided by the present invention, the thread control and calling method of the MVP processor comprises the following steps:

Step S101: allocating threads in a system operation queue to multi-path parallel hardware thread time slots for operation. In the embodiment, when the MVP processor starts running or the parallel hardware thread time slots of the MVP processor are idle, a system monitoring program (more specifically, a CPU thread management unit) is required to allocate the threads in an operation queue thereof to the parallel hardware thread time slots of the MVP processor for operation. In the embodiment, the parallel hardware thread time slots are equivalent to processor inner cores in a sense, and are equivalent to a parallel processor provided with a plurality of inner cores on hardware. In the embodiment, the biggest difference between the inner cores and general processor inner cores is that: the inner cores can operate different threads under the control of a system (namely a control system or a monitoring program of the whole MVP processor), and the threads may be traditional CPU threads and may also be traditional GPU threads. When the system starts running, all the multi-path parallel hardware thread time slots are idle. But after the system runs, the step will be executed when a multi-path parallel hardware thread time slot is idle.

Step S102: allowing an operating thread to generate call instructions of hardware threads (ithread) to a hardware thread management unit. In the embodiment, although some system threads will not produce new threads or hardware threads in the operating process, not all the operating threads are like this. Actually, most GPU threads will produce hardware threads in the operating process, particularly when the GPU threads are relevant to render. If the operating thread does not produce new hardware threads, the thread will always operate in an allocated parallel hardware thread time slot in the case of no external interrupt, until the thread is finished. If the operating thread (generally GPU thread) in the step produces hardware threads, of course, in the step, actually produces call instructions of the hardware threads, the produced call instructions of the hardware threads will be sent to the hardware thread management unit. In the embodiment, the hardware thread is ithread including a graphics engine, a DSP and/or a thread requiring hardware acceleration in a GPGPU.

Step S103: allowing the hardware thread management unit to prepare the hardware threads. As seen from the above step, the operating threads are produced by the call instructions of the ithread threads, and the ithread threads are sent to a program queue of the hardware thread management unit for queuing; and the hardware thread management unit sends sequentially thread calls in the queue thereof to the parallel hardware thread processing time slots for operation.

Step S104: allowing the prepared hardware threads to operate in idle multi-path parallel hardware thread time slots according to the sequence thereof. In the step, the ithread threads prepared by the hardware thread management unit are enabled to operate in the idle parallel hardware thread processing time slots according to the sequence thereof. What is worth mentioning, the parallel hardware thread processing time slots may be idle as there is no thread in the operation queue of the OS thread management unit, and may also stop operating threads under the control of an OS as there is an ithread thread in the hardware thread management unit, and the threads are controlled by the hardware thread management unit. In either case, as long as the parallel hardware thread processing time slot starts operating the ithread thread, the OS will lose the control power of the thread time slot, and even the timer interrupt of the time slot will be prohibited; and the control power of the time slot will be returned to the CPU only when a predetermined marker bit for retreating the hardware thread occurs. The objective of the setting is to prevent the time slots for operating the ithread threads from being interrupted by the OS as much as possible, and finish the ithread threads at the fastest speed.

In some situations, the steps S103 and S104 may be combined into one step or the step S103 is saved and the step S104 is directly executed.

In the prior art, the initial OS directly allocates the threads to the multi-path parallel hardware thread processing time slots of the MVP processor, and the action is implemented by a thread operation queue and not by a THDC; the threads operate as CPU threads and are observable and controllable for the OS (time slots for operating the threads are also included); and wherein, the thread operation queue is the operation queue from the thread created by the traditional pthread application programming interface (API) (namely hardware thread) to the OS. The special threads in the queue are directly allocated by the OS to the multi-path parallel hardware thread processing time slots. At this point, the multi-path hardware thread processing time slots are similar to “kernels” in the SMP.

In the embodiment, the ithread threads may be created in two ways: in kernel mode, the ithread threads are directly created by ithread in the THDC, and at this point, the ithread threads skip the operation queue of the OS; and in user mode, virtual pthread is operated through the queue of the OS, and the ithread threads are operated by the pthread and hence hardware threads are created. In either way, the ithread threads are all operated as coprocessor threads out of OS control in the multi-path hardware thread time slots, so that the hardware threads can be minimally interrupted by the OS in the operating process. In the embodiment, once the ithread threads are created to the THDC, the ithread threads have higher priority than the OS threads, and hence the THDC will adopt a certain number of hardware thread processing time slots to process the hardware threads. Therefore, once there are hardware threads which are valid and not finished in the THDC, the OS scheduler will not allocate threads in a queue corresponding thereto to corresponding parallel hardware thread processing time slots, that is to say, at this point, the hardware thread processing time slots are controlled by the THDC.

The ithread call instructions are supported by a pthread-like API called by a programmer, and may be directly called in user mode or called by an application driver.

In the embodiment, the ithread operates threads on the THDC through a user API. At the beginning, the ithread is usually in kernel mode (administrator mode); and when the ithread creates the threads, the threads are created to an instruction queue of the THDC. The THDC has higher priority than the OS threads.

The ithread can be produced by a driver operating on the processor in kernel mode or directly produced by an application operating on the processor in user mode. In the former case, the ithread is directly created to the THDC; and when the ithread is uploaded, the threads are operated as embedded programs without system interference. In the latter case, the ithread is operated through virtual pthread created in an operation queue of an inner core, and the pthread operates and creates a real ithread to the THDC; and the additional action only creates a record in the OS, so that a TLB exception handler thereof can handle TLB exceptions which are produced when the ithread is operated as a coprocessor thread on the multi-path parallel hardware thread processing time slot of the MVP processor in user mode.

When a kernel scheduler is going to allocate any ready thread in an operation queue thereof as an OS thread to the multi-path parallel hardware thread processing time slots for operation (in general, it means that the thread processing time slots are idle), the kernel scheduler must check whether there is a ready thread in the THDC; by adoption of the traditional scheduling mechanism, when there is a ready thread in the THDC waiting, the system scheduler will retreat from the original hardware thread processing time slot and will not put any new system thread (CPU thread). What is important is that: before retreat, the system scheduler will shut off the timer interrupt (of the time slot) and allow the ithread to get full control of the thread processing time slot without timer interrupt. Moreover, the timer interrupt can only be enabled when the ithread is retreated. After the system scheduler retreats, the THDC will obtain idle hardware thread time slots and apply the idle hardware thread time slots to ready ithread threads. When an ithread thread is finished or waits for any event for continuous operation, the ithread thread will retreat from corresponding hardware thread processing time slot; and when the valid state of an ithread thread is cleared, the ithread thread will be removed. A CPU thread will submit to the ready ithread thread which is found when the CPU thread is ready to operate and the THDC state is checked by the system scheduler.

All the ithread threads are finally created to the THDC of the MVP processor when the ithread threads are created either in kernel mode or in user mode.

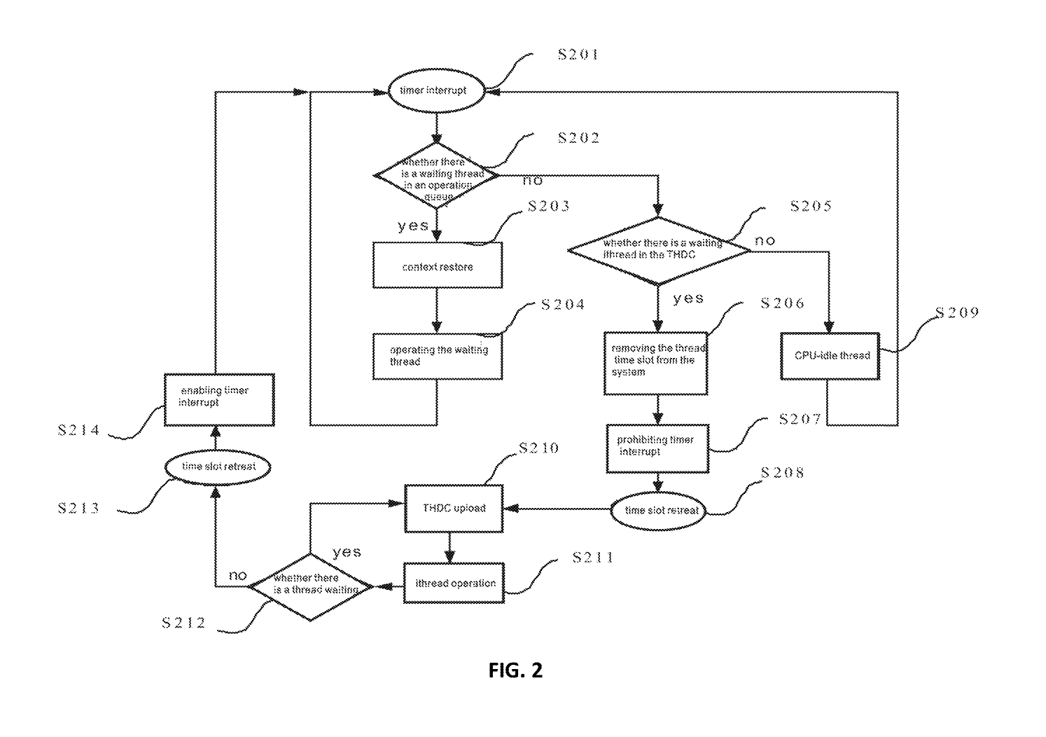

FIG. 2 illustrates the step of allocating a parallel hardware thread time slot to a CPU thread management unit or a THDC from the angle of the parallel hardware thread time slot. The step includes the following steps:

Step S201: timer interrupt. In the step, there is timer interrupt in the hardware thread time slot. As described above, the hardware thread time slot will execute timer interrupt when the system starts running or threads operating on the hardware thread time slot have been completely operated or retreated. That is to say, in the case of timer interrupt, a new thread is received by the hardware thread time slot under the control of a CPU system, and hence the operating process begins.

Step S202: detecting whether there is a waiting thread in an operation queue, and executing step S203 if so and executing step S205 if not. In the step, the operation queue refers to the operation queue in the system scheduler.

Step S203: context restore. In the step, the context restore of the thread, which will be executed when a general thread operates, is executed. That is to say, the operating environment, configuration, setting parameters and the like of the thread are restored into a predetermined area to facilitate the call of the thread in the operating process. The thread in the step is a CPU thread.

Step S204: operating the waiting thread: in the step, the thread is operated in the hardware thread time slot; and returning to the step S201 when the thread is finished or retreated.

Step S205: detecting whether there is a waiting ithread in the THDC, and executing step S206 if so and executing step S209 if not.

Step S206: removing the thread time slot from the system. In the step, as there are valid threads (the threads are all hardware threads) in the THDC has been determined in the step S205 and the threads are waiting for operation, the idle (subjected to timer interrupt) hardware thread time slots are controlled by the THDC and the waiting hardware threads are operated. In order to achieve the objective, the thread time slot must be out of system control at first and hence the control power of the thread time slot is transferred to the THDC. Therefore, in the step, the hardware time slot is removed from the system.

Step S207: prohibiting timer interrupt. In the step, when the hardware thread time slot is removed from the system, the timer interrupt of the hardware thread is shut off in such a way that time interrupt will not occur when the thread time slot operates the hardware thread.

Step S208: time slot retreat. In the step, the hardware thread time slot is retreated from the system.

Step S209: CPU-idle thread. The step is executed when there is no hardware thread in the THDC waiting for operation, that is to say, there is no traditional CPU thread and no hardware thread waiting for operation in the whole system. In this case, the hardware thread time slot calls the CPU-idle thread, which indicates there is no new thread required for processing. And hence the step S201 is returned.

Step S210: THDC upload. In the step, the THDC calls a hardware thread program, processes the called hardware thread, obtains an executable file, and uploads the obtained executable file to the hardware thread time slot.

Step S211: ithread operation: the ithread thread (namely hardware thread) operates in the hardware thread time slot.

Step S212: waiting thread: determining whether there is an ithread thread waiting, and returning to the step S211 if so and executing step S213 if not.

Step S213: time slot retreat: in the step, the hardware thread time slot is retreated from the THDC.

Step S214: enabling timer interrupt: in the step, enabling the timer interrupt of the hardware thread time slot and returning to the step S201. More specifically, in the step, as the hardware thread has been finished, the hardware thread time slot is retreated from the THDC and enables timer interrupt, namely the time slot is returned to the system.

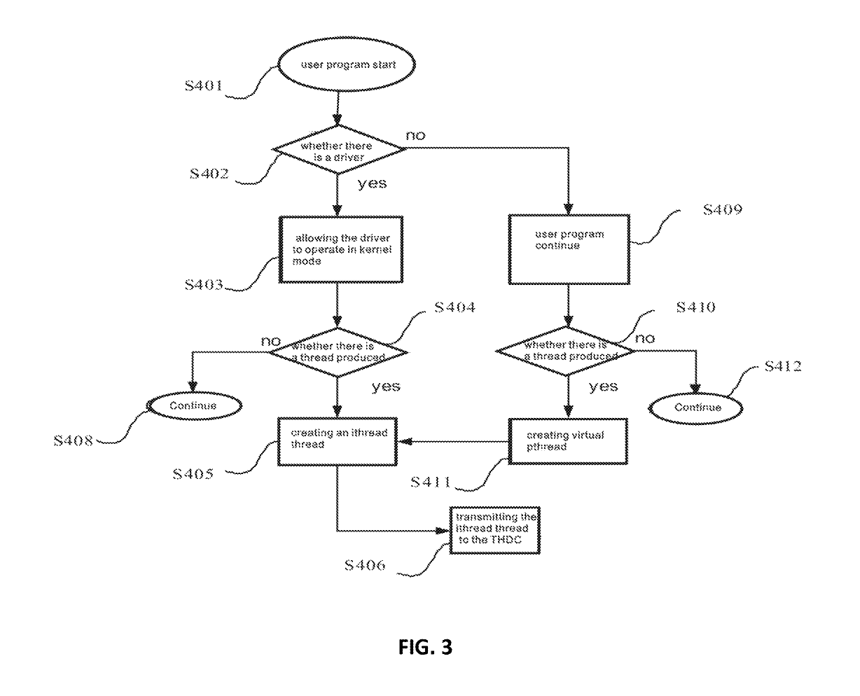

In the embodiment, the ithread thread may be produced in two cases. As illustrated in FIG. 3, the process includes:

Step S401: user program start: in the step, starting a user program, namely beginning to operate the thread on the hardware thread time slot.

Step S402: whether there is a driver: determining whether there is a driver, and executing step S403 if so and executing step S409 if not. The step is to determine the state of the hardware thread time slot before the hardware thread is created or called. Whether there is a driver in the operating thread is determined; if so, the hardware thread time slot is in kernel mode and the step S403 is executed; and if not, the hardware thread time slot is in user mode and the step S409 is executed.

Step S403: allowing the driver to operate in kernel mode. In the step, as the hardware thread time slot is in kernel mode, the hardware thread is created by the driver, and hence the driver must be operated to create the hardware thread.

Step S404: determining whether there is a thread produced, and executing step S405 if so and executing step S408 if not. In the step, the thread is a hardware thread. Whether the operating thread is required to produce (or call) a hardware thread is determined in the step. If so, the step S405 is executed; and if not, the step S408 is executed.

Step S405: creating an ithread thread. In the step, the process of creating or calling the ithread thread is actually the production of a call instruction of the ithread thread (hardware thread).

Step S406: transmitting the ithread thread to the THDC: in the step, the produced ithread thread is transmitted to the THDC and queues in a program queue thereof.

Step S408: continue: in the step, as the operating thread does not produce a hardware thread, other processing is not required and the current operating thread (the thread is a CPU thread or a GPU thread) is operated continuously.

Step S409: user program continue: as there is no driver, the hardware thread time slot is determined to be in user mode, and hence the user program is executed continuously.

Step S410: determining whether there is a thread produced, and executing step S411 if so and executing step S412 if not. In the step, the thread is a hardware thread. Whether the operating thread is required to produce (or call) a hardware thread is determined in the step. If so, the step S411 is executed; and if not, the step S412 is executed.

Step S411: creating virtual pthread. In the step, the time slot is in the user mode and the hardware thread must be created; but in the mode, the hardware thread cannot be directly created and some additional steps are required. As described above, the virtual pthread created in an operation queue of an inner core is adopted to operate and create a real ithread thread to the THDC. Therefore, in the step, the virtual pthread is created and operated; and after the step is executed, the step S405 is executed.

Step S412: continue: in the step, as the operating thread does not produce a hardware thread, other processing is not required and hence the current operating thread (the thread is a CPU thread or a GPU thread) is executed continuously.

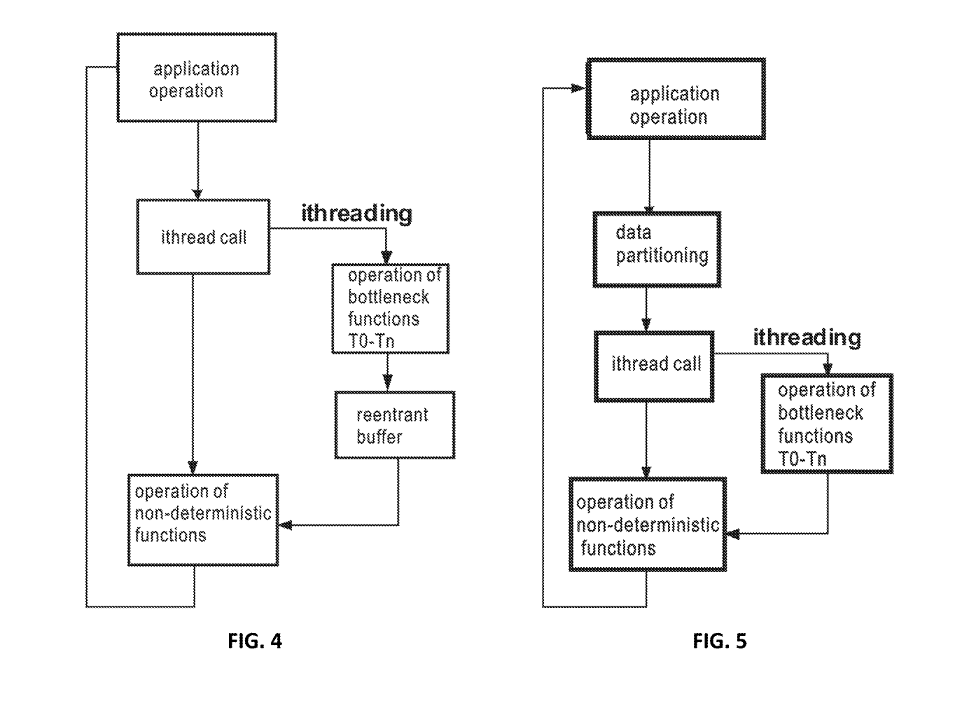

The traditional applications are “serial” when executed, namely executed step by step, and more specifically, the next step is executed after the step is executed. When the applications involve parts with concentrated calculation amount, for instance, “heating function” in FIGS. 4 and 5, the “heating function” is a bottleneck portion of the application and may be preferably accelerated. In the embodiment, the “heating function” can be accelerated by at least two means through an ithread (hardware thread) API.

FIG. 4 illustrates an accelerating mode of the part with concentrated calculation amount of the application. As illustrated in FIG. 4, when the “heating function” is called each time, an ithread thread is produced and is taken as a coprocessor thread and separate from the application for processing. After the ithread thread is created, the application operates continuously as a CPU thread until the application is ready to call the “heating function” again; at this point, an ithread thread is created again; as there are two or more than two ithread threads which are out of CPU control and operated on the hardware thread time slot as the coprocessor thread, the application must prepare some kind of reentrant buffer to maintain data outputted by the two independently operated threads. In this way, a parallel processor can independently maintain data of each “heating function”.

FIG. 5 illustrates another accelerating mode of the part with concentrated calculation amount in the application. As illustrated in FIG. 5, when the “heating function” is called each time, a predetermined ithread thread is created; after the ithread thread is created, the application operates continuously after the created ithread thread is finished; in view of flow, this means requires minimal change. But the implementation of this means must acquire in advance data relevant to the “heating function” and divide the data into small independent subsets. Therefore, data partitioning must be carried out in advance.

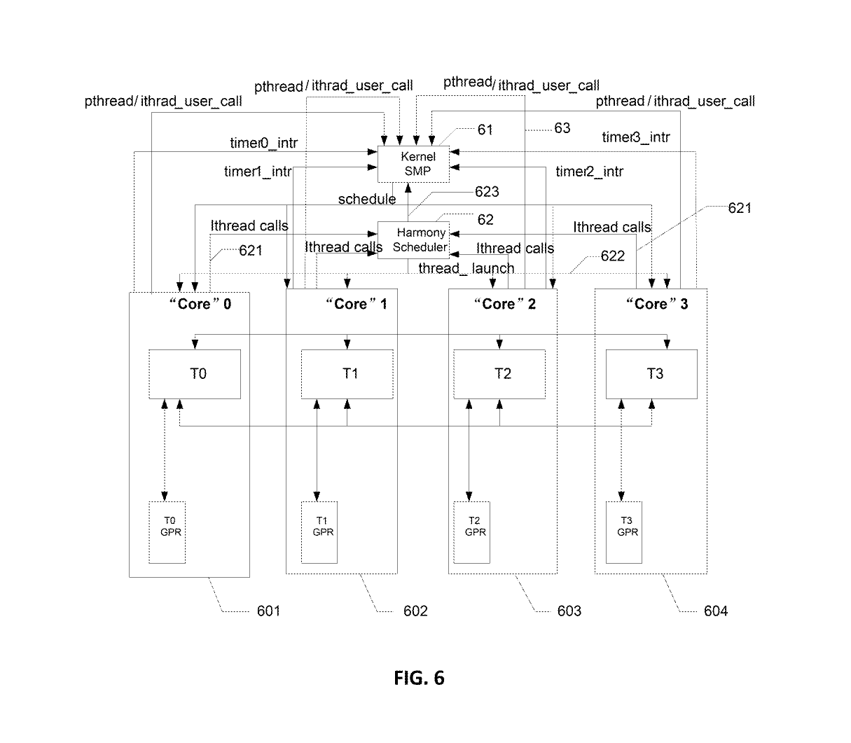

The embodiment also relates to an MVP processor. As illustrated in FIG. 6, the processor comprises a plurality of parallel processor hardware inner cores (marked as 601, 602, 603 and 604 in FIG. 6) configured to operate threads and system thread management units 61 configured to manage the system threads in the processor and allocate the threads to the processor hardware inner cores for operation, and further comprises hardware thread management units 62 configured to receive and manage hardware threads generated by an operating thread and allocate the hardware threads to idle processor hardware inner cores for operation by means of coprocessor threads. The hardware thread management units 62 are connected with the plurality of parallel processor inner cores (marked as 601, 602, 603 and 604 in FIG. 6) respectively. What is worth mentioning, the four inner cores as shown in FIG. 6 are illustrative and the number may actually be 2, 3, 4, 6 or more.

In the embodiment, the hardware thread management unit 62 acquires a hardware thread call instruction generated by the operating thread on the processor hardware inner core through a first data line 621, and each hardware inner core is connected to the hardware thread management unit 62 through the first data line 621. As illustrated in FIG. 6, the first data lines 621 are also marked as ithread calls. The hardware thread management unit 62 also sends the called and ready threads to the plurality of processor hardware inner cores for operation through second data lines 622 (also marked as thread_launch in FIG. 6). Moreover, the hardware thread management unit also sends the state of the called thread to a system thread management unit through a third data line 623.

In the embodiment, the plurality of processor hardware inner cores also transmit pthread/ithread thread call instructions generated by the operating thread in user state to the system thread management units 61 through respective fourth data lines 63; the fourth data lines 63 are marked as pthread/ithread_user_calls in FIG. 6; and each hardware inner core is connected to the system thread management unit 61 through the fourth data line. Moreover, the plurality of processor hardware inner cores and the system thread management units 61 are also connected with each other through timer interrupt request signal lines for transmitting timer interrupt signals of respective hardware inner cores; each hardware inner core is connected to the system thread management unit 61 through the timer interrupt request signal line; and the signal lines are respectively marked as timer0_intr, timer1_intr, timer2_intr and timer3_intr in FIG. 6.

The foregoing embodiments only illustrate the preferred embodiments of the present invention. Although the embodiments are described in detail, the embodiments should not be construed as the limiting of the scope of the patent of the present invention. It should be noted that various modifications and improvements may be made by those skilled in the art without departing from the concept of the present invention and should all fall within the scope of protection of the present invention. Therefore, the scope of protection of the patent of the present invention should be defined by the appended claims.

What is claimed is:

1. A thread control and calling method of a multi-thread virtual pipeline (MVP) processor, comprising the following steps:
A) allocating directly and sequentially threads in a central processing unit (CPU) thread operation queue to multi-path parallel hardware thread time slots of the MVP processor for operation;
B) allowing an operating thread to generate ithread call instructions corresponding thereto to a hardware thread management unit;
C) allowing the hardware thread management unit to enable the call instructions of ithread threads to form a program queue according to receiving time, and calling and preparing the ithread threads; and
D) allowing the ithread threads to operate sequentially in idle multi-path parallel hardware thread time slots of the MVP processor according to the sequence of the ithread threads in the queue of the hardware thread management unit.

2. The thread control and calling method of the MVP processor according to claim 1, wherein the ithread is a hardware thread and includes a graphics engine, a digital signal processor (DSP) and/or a thread requiring hardware acceleration in a general-purpose computing on graphics processing unit (GPGPU).

3. The thread control and calling method of the MVP processor according to claim 2, wherein the step A) further includes the following steps:
A1) determining whether there are hardware threads which are valid and not finished in the hardware thread management unit, and executing step A2) if so and executing step A3) if not;
A2) removing the current idle multi-path parallel hardware thread time slot from a CPU thread management unit, prohibiting the thread timer interrupt of the parallel hardware thread time slot, and allocating the idle multi-path parallel hardware thread time slot to the hardware thread management unit for control; and
A3) waiting and returning idle information of the parallel hardware thread time slot to the CPU thread management unit.

4. The thread control and calling method of the MVP processor according to claim 3, wherein the step C) further includes the following steps:
C1) removing ithread threads in the front of the program queue of the hardware thread management unit; and
C2) allocating obtained executable functions to the idle hardware thread time slot for operation.

5. The thread control and calling method of the MVP processor according to claim 4, wherein the queuing discipline of the program queue in the step C) is first-in-first-out (FIFO).

6. The thread control and calling method of the MVP processor according to claim 5, further comprising the following step:
E) allowing the ithread threads to retreat from the hardware thread time slots on which the ithread threads operate and enabling the thread timer interrupt of the time slots, when the ithread threads are finished or wait for an event for the continuous execution of the ithread threads.

7. The thread control and calling method of the MVP processor according to claim 6, further comprising the following step:
F) allowing the hardware thread management unit to detect whether the valid state of the ithread threads in the program queue of the hardware thread management unit is cleared, and removing the ithread threads if so and maintaining the ithread threads if not.

8. The thread control and calling method of the MVP processor according to claim 7, wherein in the step B), when the operating thread operates under the kernel mode of the processor, a driver of the thread directly generates the ithread call instructions and sends the ithread call instructions to an instruction queue of the hardware thread management unit.

9. The thread control and calling method of the MVP processor according to claim 7, wherein in the step B), when the operating thread operates under the user mode of the processor, virtual pthread received by an operating system (OS) symmetric multi-processing (SMP) scheduler is created to operate and produce the ithread call instructions and send the ithread call instructions to the instruction queue of the hardware thread management unit, in which the pthread is an OS thread.

10. An MVP processor, comprising a plurality of parallel processor hardware inner cores configured to operate threads and system thread management units configured to manage the threads in the processor and allocate the threads to the processor hardware inner cores for operation, further comprising hardware thread management units configured to receive and manage ithread threads generated by an operating thread and allocate the ithread threads to idle processor hardware inner cores for operation by means of coprocessor threads, the hardware thread management units connected with the plurality of parallel processor inner cores respectively.

11. The MVP processor according to claim 10, wherein the hardware thread management unit receives the ithread call instructions generated by the operating thread on the processor hardware inner core and sends called and ready threads to the plurality of processor hardware inner cores for operation.

12. The MVP processor according to claim 11, wherein the hardware thread management unit also transmits the state of the called thread to a system thread management unit though a third data line.

13. The MVP processor according to claim 12, wherein the plurality of processor hardware inner cores also respectively transmit pthread/ithread call instructions generated by the threads operating under the user state to the system thread management units through respective fourth data lines.

14. The MVP processor according to claim 13, wherein the plurality of processor hardware inner cores and the system thread management units are respectively connected with each other through timer interrupt request signal lines for transmitting timer interrupt signals of respective hardware inner cores.
